(19) United States
(12) Patent Application Publication
(10) Pub. No.: US 2026/0112339 A1
(43) Pub. Date: Apr. 23, 2026

(54) MEMORY DRUM STAND WITH DETACHABLE AND/OR COLLAPSIBLE DRUM BASKET

(71) Applicant: DRUM WORKSHOP, INC., Oxnard, CA (US)

(72) Inventor: Ruben STEINHAUSER, Altusried (DE)

(21) Appl. No.: 18/918,683

(22) Filed: Oct. 17, 2024

(51) Int. Cl. G10D 13/10

(52) U.S. Cl. CPC G10D 13/28

(57) ABSTRACT

Drum stands and drum stand baskets, including those for use with a snare drum, are described herein. Drum stands and drum stand baskets according to the present disclosure can include a detachable drum basket. Additionally, some embodiments include a plunger adjuster capable of locking a detachable drum basket to a drum stand base. Finally, some drum stands described herein include a collapsible drum basket enabling the compact storage and transportation of the drum basket.

### BACKGROUND OF THE INVENTION

### Field of the Invention

This invention relates generally to drum stands, and in particular to drum stands incorporating drum baskets, such as snare drum stands and snare drum baskets.

### Description of the Related Art

Snare drums are common and widely used percussion instruments. The snare drum can sometimes be the center component and most prominent piece in a drum set. Snare drums are frequently used in orchestras, marching bands, concert bands, parades, drum corps, and many other applications. The snare drum is highly accessible and often used as a teaching aid for new drummers.

Snare drum stands may be used to hold the snare drum in place for actuation by a user. Such snare drum stands are often used in settings where the drummer is sitting, such as in bands/orchestras and drum kits. Many snare drum stands include a mechanism for adjusting the angle of the snare drum such that the top head is more easily struck by the user. Examples of prior art drum stands, features of which can be combined with those of the present disclosure, include U.S. Pat. No. 8,395,039 to Steinhauser et al., filed on Jul. 30, 2010; and U.S. Pat. No. 9,721,549 to Sikra et al., filed on Jan. 20, 2016; each of which is fully incorporated by reference herein in its entirety.

A common problem with drum stands is that they can be heavy and/or difficult to move. Relatedly, some snare drum stands lack the ability to collapse, which makes them difficult to store and/or transport. Snare drum stands that do collapse lack the ability to achieve a user's desired drum angle upon redeploying the snare drum stand after it has been collapsed, thereby causing user frustration and/or inconsistent “feel” from one playing session to another, and/or taking excessive amounts of time to redeploy the stand in the correct position.

Accordingly, there is a present need for a novel and efficient design for a drum stand, such as a snare drum stand, which specifically deals with one or more of the aforementioned problems.

### SUMMARY OF THE DISCLOSURE

One embodiment of a stand for percussive instruments according to the present disclosure can include a drum stand base having a tube and a basket catch above the tube. The basket catch can be configured to connect to a drum basket, and can be rotatable relative to the tube.

One embodiment of a detachable drum basket according to the present disclosure can include a body defining a cavity, a plurality of arms, and an assembly at least partially in the cavity comprising a stand connector, an actuation mechanism external to the body, and a connecting device between the stand connector and actuation mechanism. In some embodiments, the assembly is a plunger assembly. Plunger assemblies according to the present disclosure can include a rod connected to a pull mechanism, a spring on the rod between the pull mechanism and a stand connector at least partially within the cavity while in a resting state, and a plunger adjuster on the rod.

An embodiment of a collapsible drum basket according to the present disclosure can include a body comprising at least one cutout, at least one side arm connected to the body via an arm fastener, and at least one bottom arm connected to the body via an arm fastener. The side arm(s) may rotate about the arm fastener(s) and rest in a cutout when in a collapsed position.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a side view of one embodiment of a drum stand according to the present disclosure.

FIGS. 2A-2G show various views of one embodiment of a detachable drum basket according to the present disclosure.

FIGS. 3A-3D show various views of another embodiment of a collapsible drum basket according to the present disclosure.

FIGS. 4A-4E show various views of one embodiment of a drum stand base according to the present disclosure.

### DETAILED DESCRIPTION OF THE DISCLOSURE

The present disclosure relates to drum and/or cymbal stands and assemblies, such as snare and/or tom drum stands, and snare and/or tom drum stand baskets. Embodiments of the present disclosure can include features for enabling use with differently sized drums, allowing better sound quality due to a novel drum holding concept, and/or enabling easy compacting and/or storage with repeatable drum angle upon stand deployment.

Throughout this description, the preferred embodiment and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the terms “and/or,” “and,” and “or” include any and all combinations of one or more of the associated list items unless the context clearly requires otherwise.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. Like elements among embodiments are referenced herein with the same reference numerals, except where differences are articulated.

It is understood that while the present application is written using the terms “drums,” “hi-hats,” and “cymbals” and with musical instruments generally in mind, the devices, methods, and concepts herein could be applied to fields other than musical instruments, as would be understood by one of skill in the art, including but not limited to tools, including test engineer setups. Moreover, when feature(s) or element(s) are described with regard to one embodiment (e.g., a snare or tom drum stand), it should be understood that those feature(s) or element(s) could be used in other embodiments (e.g., a tool, etc.). It should also be understood that any time reference to a snare stand or a tom stand is made, these same devices and concepts could be to one another, as such stands can often be used interchangeably.

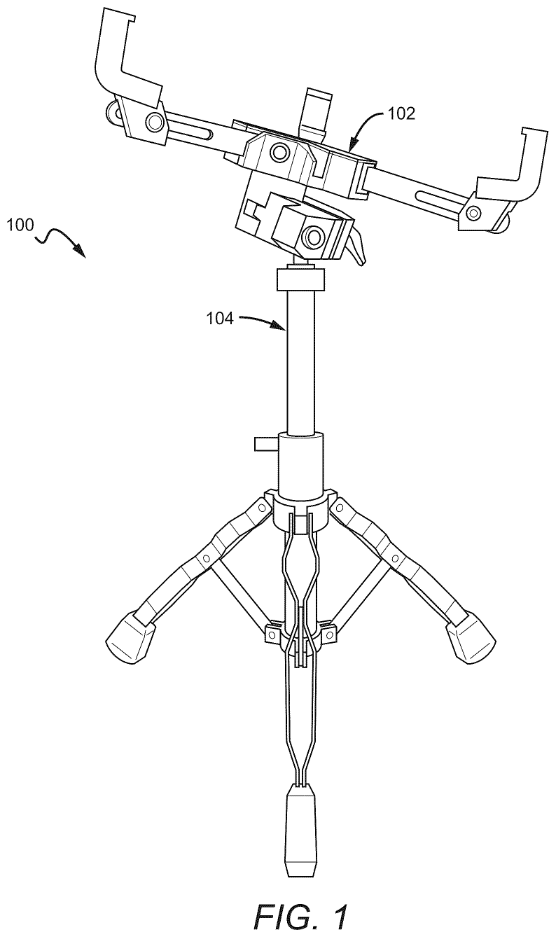

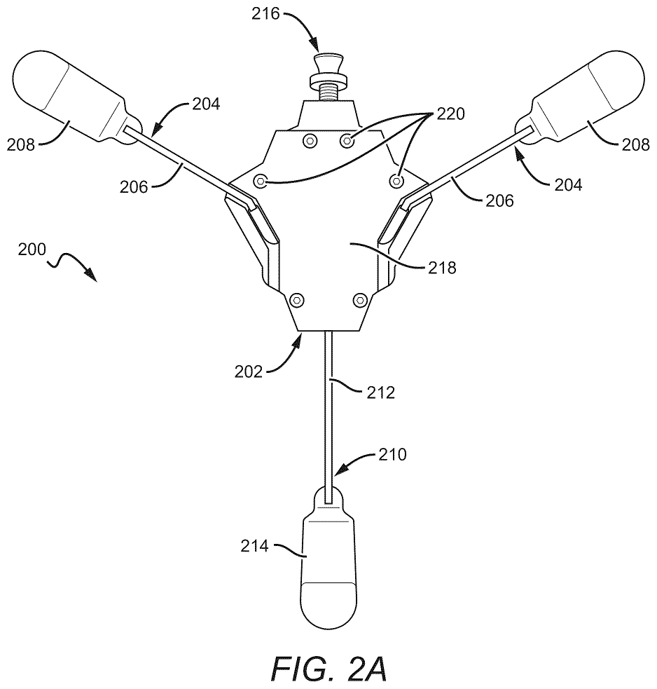

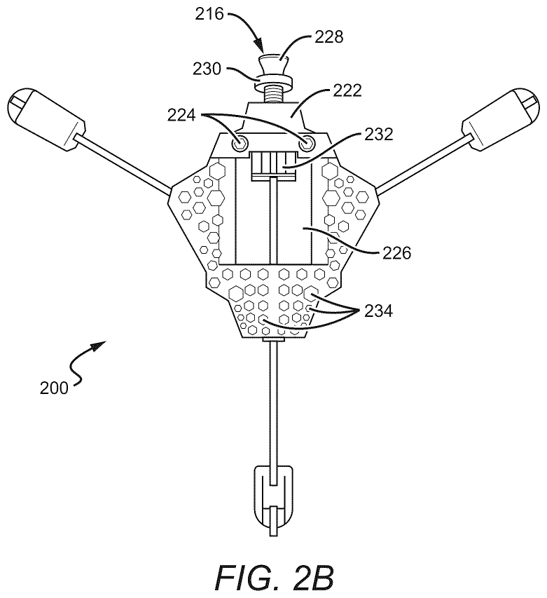

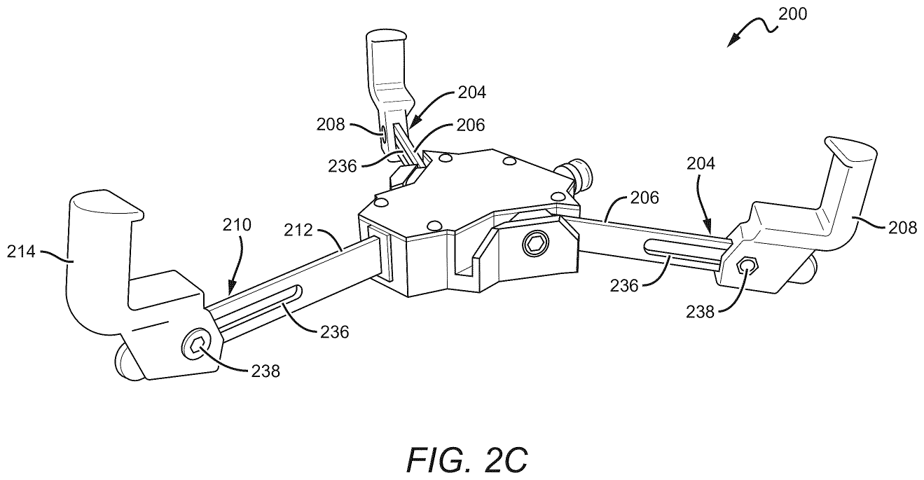

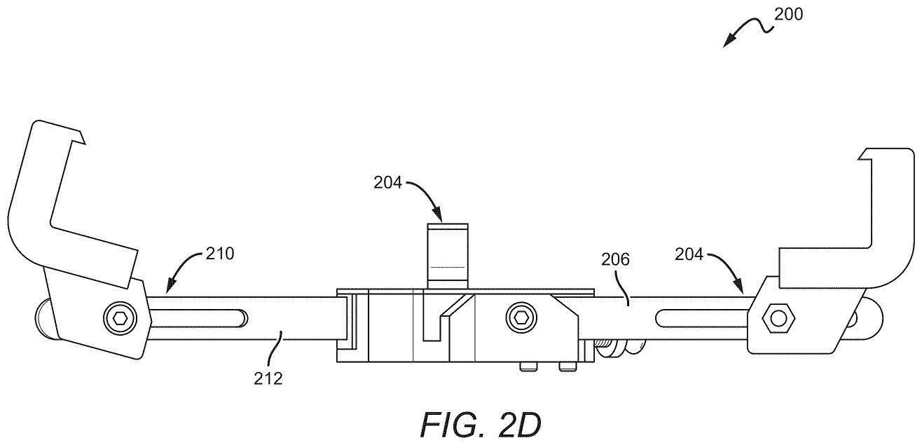

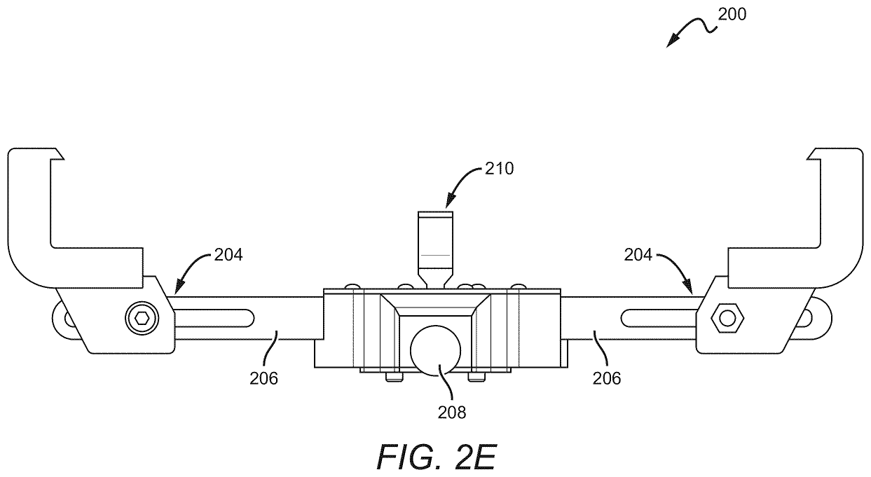

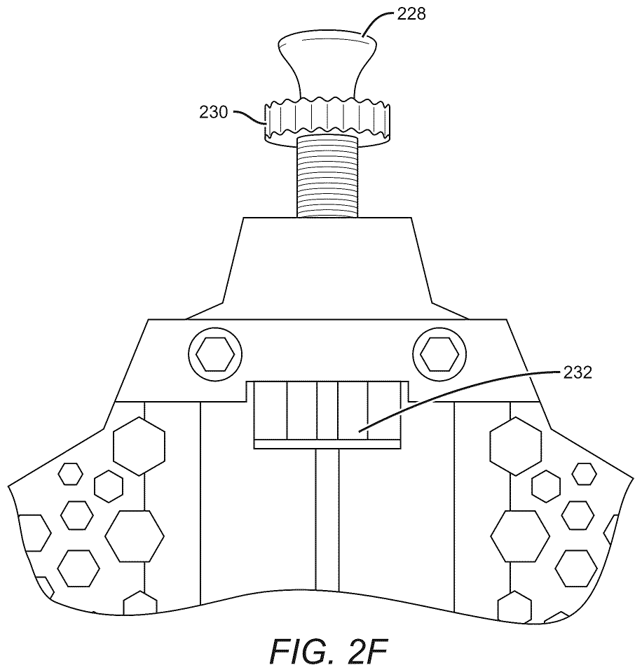

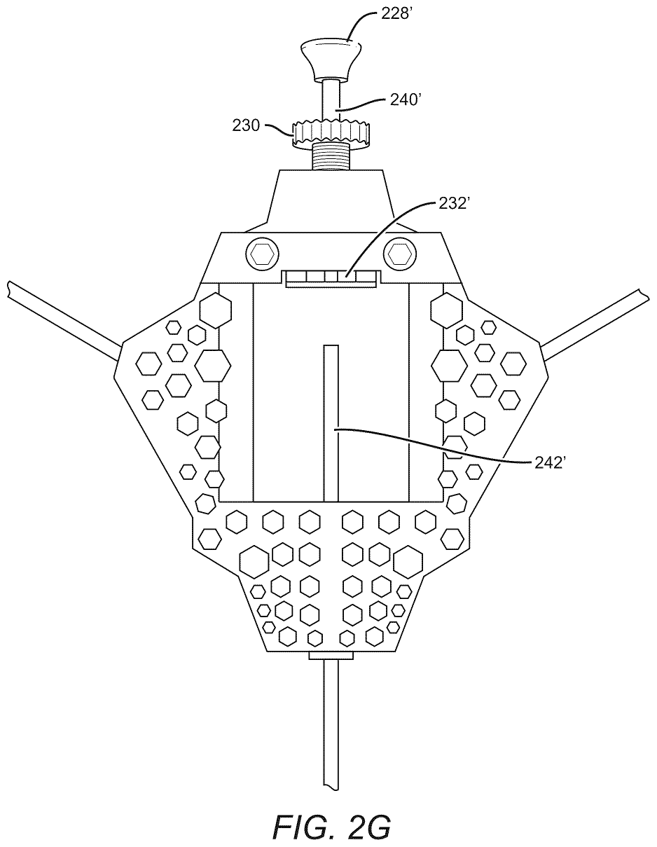

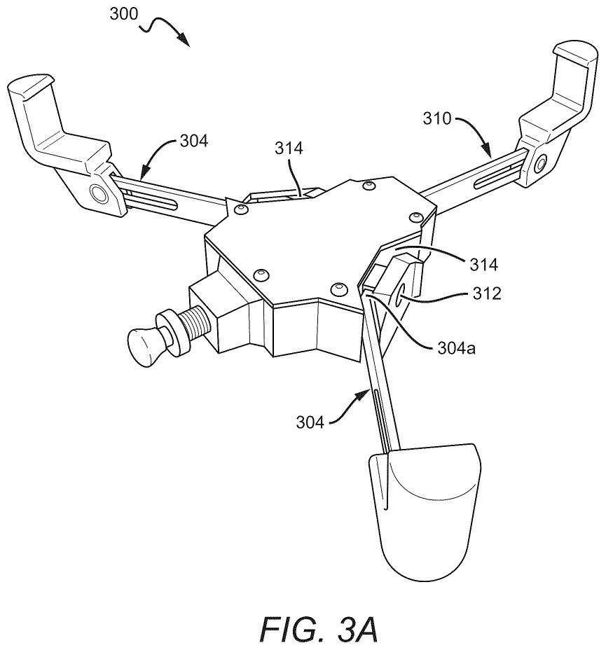

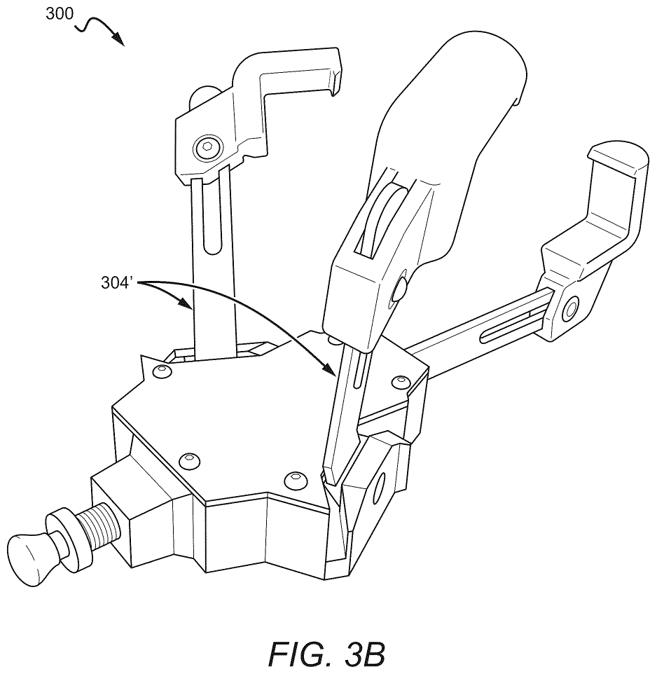

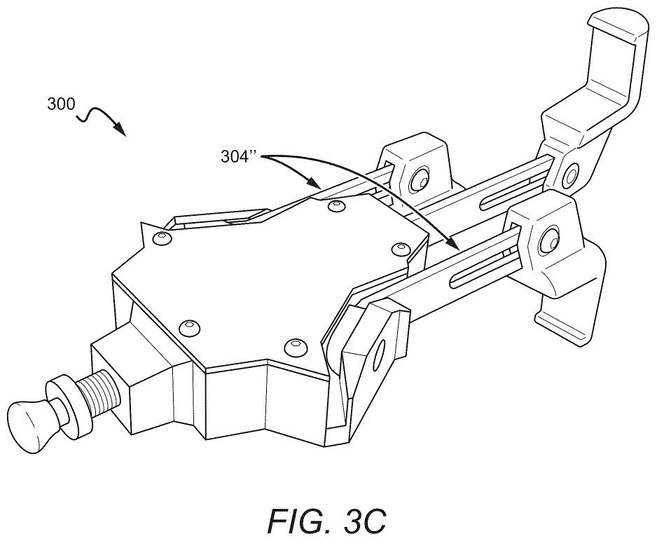

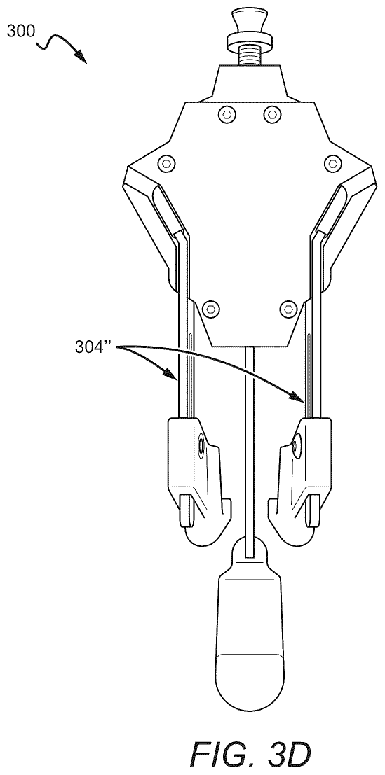

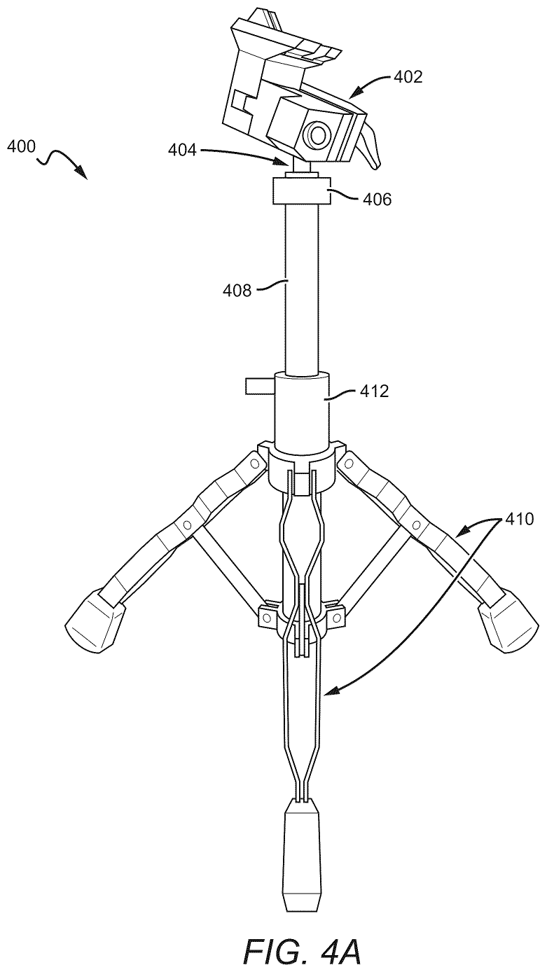

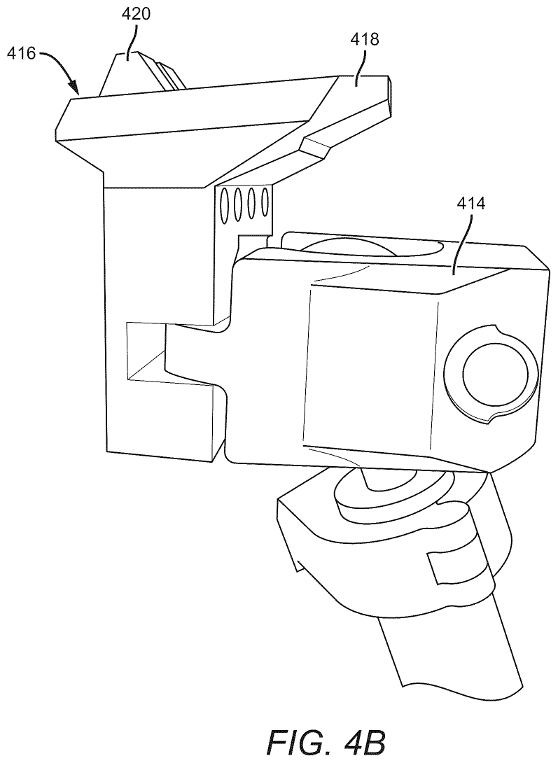

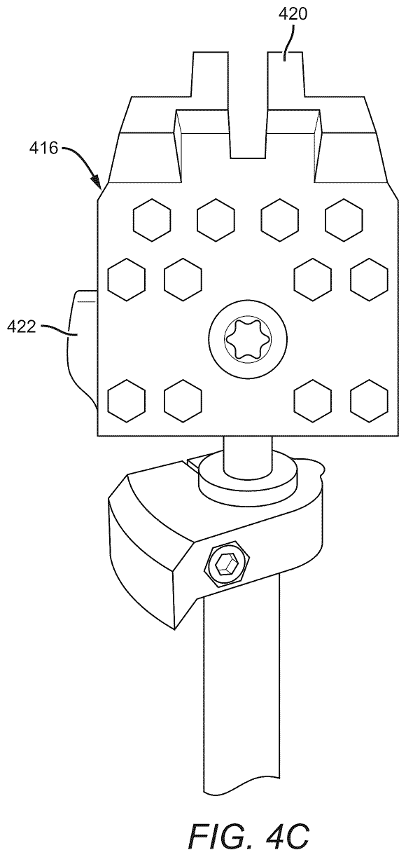

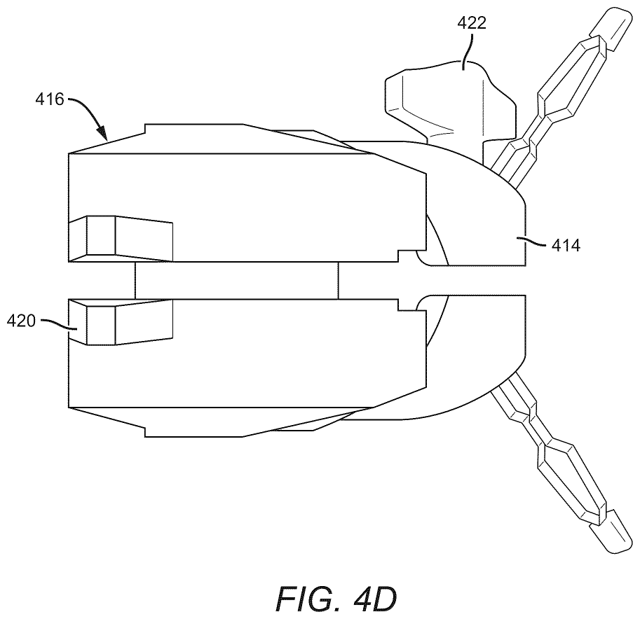

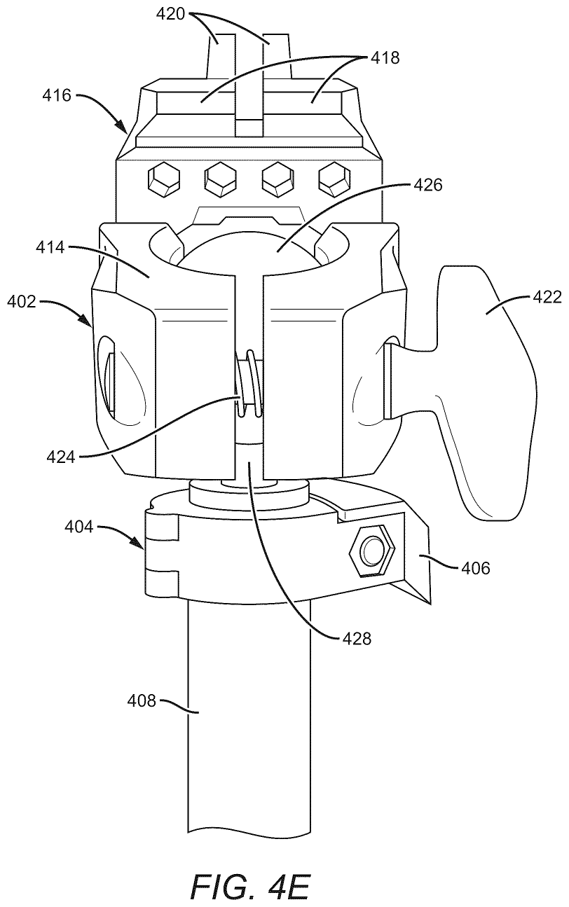

FIG. 1 is a perspective view of one embodiment of a drum stand 100 for use with a drum, such as for example a snare drum or a tom drum, according to the present disclosure. The drum stand 100 may comprise, in some embodiments, a drum basket 102 (such as a detachable drum basket, as described below in reference to FIGS. 2A-2G, and/or a collapsible drum basket as described below in reference to FIGS. 3A-3D) and a drum stand base 104 (such as the drum stand base described below in reference to FIGS. 4A-4E). The drum basket 102 may be configured to hold a drum via, for example, arms. As shown, the drum basket 102 can be tilted to a particular angle relative to the drum stand base 104, such that the top head of a drum is more accessible to and/or angled toward a user for actuation.

### Detachable Drum Basket

FIGS. 2A-2G show various views of one embodiment of a detachable drum basket 200 (which may be the same as or similar to the drum basket 102) according to the present disclosure. As shown in FIG. 2A, the detachable drum basket 200 may comprise one or more of a body 202; one or more side arms 204 (in this case, two side arms, though few or more than two are possible), which may each comprise a side arm bracket 206 and a side arm tip 208; one or more bottom arms 210, which may each comprise a bottom arm bracket 212 and a bottom arm tip 214; and a plunger assembly 216. Some drum baskets 200 according to the present disclosure may comprise a top plate 218, which, in more specific embodiments, may be attached to the body 202 via top plate fasteners 220. The top plate fasteners 220 can include many different types of connectors as known in the art, such as drum key screws, screws, nuts, bolts, nails, pins, and other similar and dissimilar devices serving the purpose of connecting two things. It is understood that the top plate 218 and the body 202 may, in some embodiments, be formed as one component, i.e., as a singular, monolithic piece.

The detachable drum basket 200 may hold a drum, e.g., a snare drum or tom, by resting the drum on the body 202 and by contacting one or more of the side arms 204 and/or the bottom arm 210 with the drum to secure it. While two side arms 204 are shown in FIGS. 2A-2G, it is understood that more or less side arms 204 are possible, such as one or more, three or more, three or fewer, four or more, four or fewer, or any other number of arms. Similarly, while one bottom arm 210 is shown in FIGS. 2A-2G, it is understood that more bottom arms 210 may be used, such as two or more, two or fewer, three or more, three or fewer, etc. Additionally, some embodiments of a detachable drum basket 200 according to the present disclosure include only side arms 204 or only bottom arms 210. Many configurations are possible.

Each of the body 202, side arm bracket 206, bottom arm bracket 212, and top plate 218 may comprise, for example, a metal (such as steel, aluminum, brass, or other metals known in the art), a plastic, wood, composites, or other materials known in the art, or combinations of any of these. The aforementioned components may comprise the same material or combinations or different materials both within the same component (e.g., the body 202 may comprise, for example, plastic and metal) and across components (e.g., the body 202 may comprise plastic, while the side arms 204 comprise metal).

The side arm tips 208 and the bottom arm tip 214 may comprise a relatively soft and/or non-metal material, such as for example, rubber, plastic, wood, or other materials known in the art suitable to hold a drum, i.e. to prevent or reduce marring of a drum when inserted in the detachable drum basket 200. In some embodiments, the specific material of either or both of the side arm tip 208 and the bottom arm tip 214 may prevent or reduce a change in sound to the drum by virtue of contacting the detachable drum basket 200.

FIG. 2B shows a bottom view of the detachable drum basket 200. In some embodiments, the detachable drum basket 200 further comprises a bottom plate 222 that may be secured to the body 202 via bottom plate fasteners 224, which may be the same as or similar to the top plate fasteners 220. Like the top plate 218, the bottom plate 222 may be integrally formed with the body 202, i.e., as one monolithic piece. In certain embodiments, the body 202 forms a cavity 226, such as an open cavity and/or a cavity in the underside (or other side) of the body 202. Some embodiments of a plunger assembly 216 according to the present disclosure include a pull mechanism such as a knob 228, a plunger adjuster 230, a spring (not shown), and/or a stand connector 232. The body 202 may, in some embodiments, contain holes 234, be hollow, and/or include hollow areas (separate from the cavity 226) to reduce overall detachable drum basket 200 weight. While “knob” 228 is used herein for consistency, one of skill in the art would understand that other handles and pulls (referred to collectively herein as “pull mechanisms”) are possible.

With reference to FIGS. 2C-2E, the side arm brackets 206 and the bottom arm bracket 212 may comprise adjustment slots or channels 236 (referred to hereinafter as adjustment slots for simplicity). Some embodiments of side arm tips 208 and/or bottom arm tip 214 comprise one or more holes (not shown) through which tip fasteners 238 may be inserted. The tip fasteners 238 can include many different types of connectors as known in the art, such as drum key screws, screws, nuts, bolts, nails, pins, and other similar and dissimilar devices serving the purpose of connecting two things. When tightened, the tip fasteners 238 may frictionally attach the side arm tip 208 and/or the bottom arm tip 214 to the side arm bracket 206 and/or the bottom arm bracket 212, respectively. When loosened, the side arm tip 208 and/or the bottom arm tip 214 may slide within the side arm bracket 206 and/or the bottom arm bracket 212, respectively. By adjusting the side arm tips 208 and the bottom arm tip 214, the detachable drum basket 200 can accommodate varying sized drums. The detachable drum basket 200 may accommodate drums with a diameter of between 6-20 inches in diameter, or 8 -18 inches in diameter, or 10-15 inches in diameter, or 4 inches diameter or greater, 6 inches diameter or greater/less, 8 inches diameter or greater/less, 10 inches diameter or greater/less, 12 inches diameter or greater/less, 15 inches diameter or greater/less, 18 inches diameter or greater/less, 20 inches diameter or greater/less, ranges within combinations of these measurements, standard snare and tom sizes, and other sizes as would be understood by one of skill in the art. Many different diameters of drums within and outside these ranges are possible.

As shown in FIG. 2F, while in an equilibrium position, the stand connector 232 may be at least partially in the cavity 226. To operate the plunger assembly 216, a user may grip the knob 228 (or another portion of the plunger assembly 216) and pull it away from the body 202. In so doing, the stand connector 232 may be pulled at least partially out of the cavity 226, e.g., to the position 232′ in FIG. 2G. Similarly, the knob 228 is shown pulled away from the body 202 in an extended position 228′ in FIG. 2G. In some embodiments, the knob 228 is connected to the stand connector 232 through a rod 240, as best seen in FIG. 2G. The spring imparts a restoring force on the knob 228′ and stand connector 232′, such that removal of the user's pulling force may cause both components to return to their equilibrium position, as shown in FIG. 2B. By operating the plunger assembly 216 in such a fashion, the detachable drum basket 200 can be releasably attached to a drum stand base, such as the embodiment described below with respect to FIGS. 4A-4E. In some embodiments, at least a segment 242 of the bottom arm bracket 212 may extend into the cavity 226, and a drum stand base such as that described below can include a corresponding feature or aperture for accommodating, mating with, or interlocking with the segment 242.

In some embodiments according to the present disclosure, rotation of the plunger adjuster 230 changes the operable length of the spring. By, for example, shortening the operable length of the spring, the distance the knob 228 and the stand connector 232 may travel when pulled by a user is reduced. In more specific embodiments, rotation of the plunger adjuster 230 to a certain point “locks” the knob 228 and the stand connector 232 such that a user cannot easily pull the knob 228 and thus cannot easily retract the stand connector 232. In such embodiments, a user may lock the stand connector 232 to prevent inadvertent separation of the detachable drum basket 200 from a drum stand base, such as the embodiment described below with respect to FIGS. 4A-4E. Once the user desires to separate the detachable drum basket 200 from a drum stand base, they can rotate the plunger adjuster 230 the opposite direction, increasing the operable length of the spring and thus enabling the knob 228 to be more easily pulled. Other locking mechanisms are possible as would be understood by one of skill in the art.

### Collapsible Drum Basket

FIGS. 3A-3D show various views of a collapsible drum basket 300 according to one embodiment of the present disclosure. It should be understood that the collapsible drum basket 300 may include the same or similar components as the drum basket 200, and may even be the same as the drum basket 200; that is, some or all of the features of the drum basket 200 and some or all of the features of the drum basket 300 may be included in a single drum stand. Alternatively, they could be different or separate embodiments.

The collapsible drum basket 300 may comprise one or more of a body 302 (which can be the same as or similar to the body 202), side arms 304 and bottom arms 310 (which can be the same as or similar to the side arms 204 and bottom arms 210, respectively), connected to the body 302 via arm fasteners 312. In some embodiments, the body 302 further comprises cutouts 314.

The collapsible drum basket 300 is capable of collapsing to reduce its overall footprint and to ease storage and transportation. FIG. 3A shows the collapsible drum basket 300 in an unfurled position, FIG. 3B depicts the collapsible drum basket 300 in a transition position, and FIGS. 3C-3D show the collapsible drum basket 300 in a collapsed position. To collapse the collapsible drum basket 300, a user may rotate the side arms 304 about the arm fasteners 312 to their vertical position 304′ shown in FIG. 3B, and finally to their folded position 304″ shown in FIGS. 3C-3D. The side arms 304 in their folded position 304″ may rest in the cutouts 314 to permit the collapsible drum basket 300 to collapse substantially flat. Some embodiments of side arms 304 according to the present disclosure include a bent or curved portion 304a (as shown in FIG. 3A) to permit rotation between positions parallel with the bottom arm 310—as shown in FIGS. 3C and 3D—and a deployed and/or non-parallel position compared to the bottom arm 310—as shown in FIG. 3A. The cutouts 314 can be shaped to accommodate some or all of the bent/curved portions 304a, and some of the non-bent/curved positions. The cutouts 314 can also be shaped and/or have a depth such that the side arms 304 and bottom arm 310 (or at least portions thereof) are approximately coplanar when in the folded position, as shown in FIG. 3C.

### Drum Stand Base

FIGS. 4A-4E show one embodiment of a drum stand base 400 (which may be the same as or similar to the drum stand base 104) according to the present disclosure. Embodiments of drum stand bases 400 according to the present disclosure may comprise one or more of a socket assembly 402, a ball assembly 404 (as best seen in FIG. 4E), a height adjuster 406, a tube 408, legs 410, a leg sleeve 412 capable of collapsing the legs 410, and/or other standard drum stand base components.

Referring to FIG. 4B, some embodiments of socket assemblies 402 according to the present disclosure comprise one or more of a ball clamp 414 and a basket catch 416, which itself may comprise one or more protrusions 418 and one or more alignment fins 420. With reference to FIG. 4E, some socket assemblies 402 may further comprise a connector (e.g., a wing bolt) 422 and a spring 424. Still referring to FIG. 4E, some embodiments of ball assemblies 404 according to the present disclosure comprise one or more of a ball 426 and a shank 428.

Components of the drum stand base 400 may comprise lightweight and/or sturdy materials, for example, one or more metals (such as steel, aluminum, brass, or other metals known in the art) plastic, wood, composites, or other materials known in the art. The ball 426 may comprise a low friction material, such as for example polymers and other low friction materials known in the art, and/or a low friction coefficient coating, such as tungsten disulfide, nicklon, and others known in the art.

With reference to FIG. 4A, the socket assembly 402 can be rotated about the ball 426 such that the basket catch 416 can be angled relative to the tube 408. In some embodiments, the angle can be adjusted 360° in the plane perpendicular to the tube, and/or can be adjusted angularly upward or downward. While 360° upward/downward adjustment is impractical (e.g., because of the rest of the stand assembly), the angle can be adjusted in a span of 10° or more, 22.5° or more, 35° or more, 45° or more, 60° or more, 90° or more, 120° or more, 180° or more, 225° or more, 270° or more, or other angular spans. The span can be from vertical facing downward in one direction, or downward in two directions from vertical (e.g., for an embodiment with a 90° span of adjustability, it could be downwardly adjustable 45° in both directions). Embodiments of the present disclosure can include a locking mechanism for locking the angle of the basket catch 416 in place relative to the tube 408 when in a first position or configuration (e.g. a locked and/or tightened configuration), and for allowing adjustment of the angle of the basket catch 416 relative to the tube 408 when in a second position or configuration (e.g. an unlocked and/or loosened configuration). For instance, the locking mechanism may include a connector such as a wing bolt 422. In some embodiments according to the present disclosure, loosening the wing bolt 422 expands the ball clamp 414 due to the spring 424. As a result, the socket assembly 402 (including the basket catch 416) is free to rotate about the ball 426. Conversely, when the wing bolt 422 is tightened, the spring 424 is compressed and the ball clamp 414 frictionally connects to the ball 426, preventing or reducing rotation thereabout. It should be understood that attachment components and connectors other than a wing bolt are possible, such as those attachment and connection components described elsewhere herein. Additionally, the ball assembly 404 can be raised or lowered by loosening the height adjuster 406, thus permitting vertical movement of the shank 428 within the tube 408. Other height adjustment mechanisms as known in the art could also be used. It should also be understood that the ball and/or ball assembly 404 can be, but need not necessarily be, fully spherical; for instance, frustospherical and hemispherical embodiments are possible.

In some embodiments according to the present disclosure, the protrusions 418 can engage with a detachable drum basket, such as for example the detachable drum basket 200. For example, the basket catch 416 can be placed inside a cavity (e.g. the cavity 226) of a detachable drum basket having a stand connector (e.g. the stand connector 232). In its resting position, the stand connector is at least partially disposed in the cavity, thus preventing the insertion of the basket catch 416 in the cavity. A user can pull the stand connector away toward the outside of the cavity (e.g., so it is more partially out of the cavity or is out of the cavity; and/or as shown in FIG. 2G) to permit the insertion of the basket catch 416 in the cavity of a detachable drum basket. After inserting the basket catch 416 in the cavity, the user can allow the stand connector to return to the cavity and/or to its resting position. In so doing, the stand connector can frictionally engage the bottom face of the protrusions 418, thereby releasably connecting the detachable drum basket to the drum stand base 400. In some embodiments, the alignment fins 420 may engage with, for example, the segment 242 of the bottom arm bracket 212 to radially orient the basket on the basket catch 416, though it should be understood that other engagement mechanisms are possible for both the basket catch 416 and the basket are possible. The detachable drum basket may be detachable from the drum stand base 400 by pulling the stand connector, thus permitting removal of the basket catch 416 from the cavity of the detachable drum basket.

It should be understood that the components that enable attachment of the detachable drum basket to the drum stand base 400 could be reversed; e.g., those attachment components described above as part of the drum basket could be part of the base, and vice versa, as would be understood by one of skill in the art.

Because the angle of the basket catch 416 can determine the angle of the detachable drum basket when releasably attached to the drum stand base 400, the detachable drum basket can be attached and detached repeatedly with an identical or substantially similar angle. This can be achieved much faster than in prior art breakdowns and setups, because the basket catch 416 need not be removed or even adjusted as part of a breakdown of the base 400, thus enabling the angle to remain constant each time the components are assembled together. By extension, a drum can be attached to and detached from the drum stand base 400 with a consistent angle when attached, allowing a user to experience the same or similar drum setups across multiple playing sessions. In this sense, the drum stand base 400 retains a “memory” of the user's preferred drum angle. The basket catch 416 can be lighter than and/or have smaller profile dimension(s) than the basket to be attached thereto, thus enhancing transportability and packability.

While the embodiment of FIGS. 4A-4E specifically shows a ball and socket assembly, it should be understood that many different angular adjustment mechanisms are possible, such as embodiments utilizing one or more axles and components rotatable about the axle(s), hinge embodiments, pin connection embodiments, connector embodiments, and other embodiments as would be understood by one of skill in the art. Additionally, while a specific plunger mechanism has been disclosed herein for connecting the drum basket to the drum stand base and/or basket catch, it should be understand that many different embodiments are possibly, including but not limited to lever connections, push-button/push-release connections, snap connections, fastener connections, material connections (e.g. using adhesives, hook-and-loop fasteners, etc.), and other embodiments, and as such the present disclosure should not be considered to be limited in this manner.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the invention.

I claim:

1. A stand assembly for percussive instruments, comprising:
a drum stand base, comprising:
a tube; and
a basket catch above said tube, wherein said basket catch is configured to connect to a drum basket and is rotatable relative to said tube.

2. The stand assembly of claim 1, wherein said basket catch is rotatable 360° about said tube.

3. The stand assembly of claim 1, wherein a height of said basket catch is adjustable.

4. The stand assembly of claim 1, said drum stand base further comprising a locking mechanism, wherein said locking mechanism is configured to lock the angle of said basket catch relative to said tube into place when in a first position, and configured to allow adjustment of the angle of said basket catch relative to said tube when in a second position.

5. The stand assembly of claim 1, wherein said basket catch is part of a socket assembly, said drum stand base further comprising a ball assembly between said tube and said socket assembly;
wherein said socket assembly is rotatable about said ball assembly.

6. The stand assembly of claim 5, wherein said drum stand base further comprises a height adjuster;
wherein said ball assembly comprises a ball and a shank; and
wherein said height adjuster is configured to permit vertical movement of said shank within said tube when in a loosened position, and configured to lock said shank into place when in a tightened position.

7. The stand assembly of claim 5, wherein said ball assembly comprises a ball and a shank, and wherein said socket assembly further comprises:
a ball clamp connected to said basket catch and configured to accept said ball; and
a connector within a hole in said ball clamp, wherein tightening said connector frictionally engages said ball clamp and said ball.

8. The stand assembly of claim 1, further comprising said drum basket.

9. The stand assembly of claim 8, wherein said drum basket comprises:
a body;
one or more arms connected to said body; and
a plunger assembly operable to connect said drum basket to said basket catch.

10. The stand assembly of claim 9, wherein said body is shaped to define a cavity configured to accept said basket catch, and wherein said plunger assembly comprises:
a stand connector at least partially within said cavity and configured to engage said basket catch;
a pull mechanism; and
a spring between said pull mechanism and said stand connector.

11. The stand assembly of claim 8, wherein said basket catch comprises alignment fins configured to radially orient said drum basket on said drum stand base.

12. A detachable drum basket comprising:
a body defining a cavity;
a plurality of arms connected to said body;
an assembly disposed at least partially in said cavity and comprising:
a stand connector at least partially in said cavity;
an actuation mechanism external to said body and configured to actuate said stand connector; and
a connecting device connecting said stand connector and said actuation mechanism.

13. The detachable drum basket of claim 12, wherein said assembly is a plunger assembly, said actuation mechanism is a pull mechanism, and said connective device is a rod, said detachable drum basket further comprising a spring on said rod between said pull mechanism and said stand connector.

14. The detachable drum basket of claim 13, further comprising a plunger adjuster on said rod.

15. The detachable drum basket of claim 14, wherein adjustment of said plunger adjuster changes the operable length of said spring.

16. The detachable drum basket of claim 15, wherein adjustment of said plunger adjuster locks said plunger assembly such that said pull mechanism is substantially locked in place.

17. The detachable drum basket of claim 12, wherein said stand connector is configured to releasably engage a drum stand base.

18. The detachable drum basket of claim 12, wherein each of said plurality of arms comprises:
an arm bracket having a distal end and comprising a slot;
an arm tip on said distal end of said arm bracket; and
a tip fastener configured to releasably connect said arm tip to said arm bracket through said slot.

19. The detachable drum basket of claim 18, wherein said arm tips are adjustable by loosening said tip fastener and sliding said tip fastener within said slot.

20. A collapsible drum basket comprising:
a body comprising at least one cutout;
at least one side arm connected to said body via an arm fastener, said at least one side arm configured to rotate about said arm fastener and to rest in said at least one cutout when in a collapsed position; and
at least one bottom arm connected to said body via an arm fastener.

21. The collapsible drum basket of claim 20, wherein said at least one side arm is substantially parallel with said at least one bottom arm when in said collapsed position.

22. The collapsible drum basket of claim 21, wherein said at least one side arm is configured to lay substantially planar with said body when in said collapsed position.

23. The collapsible drum basket of claim 22, wherein said at least one side arm is bent.

24. The collapsible drum basket of claim 20, wherein said body is configured to releasably attach to a drum stand base.

25. The collapsible drum basket of claim 20, comprising two of said side arms, wherein each of said side arms is substantially parallel with said at least one bottom arm when in said collapsed position.
